(19) United States
(12) Patent Application Publication
(10) Pub. No.: US 2017/0300085 A1
(43) Pub. Date: Oct. 19, 2017

(54) ACCESSORY FOR PORTABLE ELECTRONIC DEVICE

(71) Applicant: HTC Corporation, Taoyuan City (TW)

(72) Inventor: Mathias Andreas Hintermann, San Francisco, CA (US)

(73) Assignee: HTC Corporation, Taoyuan City (TW)

(21) Appl. No.: 15/447,139

(22) Filed: Mar. 2, 2017

Related U.S. Application Data
(60) Provisional application No. 62/313,827, filed on Mar. 28, 2016.

(51) Int. Cl. G06F 1/16; A45C 11/00; A45C 13/00; A45F 5/00

(52) U.S. Cl. CPC G06F 1/1626; A45C 13/002; G06F 1/1652; A45F 5/00; A45C 11/00; A45C 2011/002; G06F 2200/1633; A45C 2011/003

(57) ABSTRACT

An accessory is adaptable for a portable electronic device, including a display and a rear surface facing away from the display. The accessory includes a cover portion, a magnetic portion and a shielding portion. The cover portion is completely transparent or semi-transparent, and adaptable to cover the display of the portable electronic device. The magnetic portion is disposed within the cover portion. The shielding portion is disposed within the cover portion. When the cover portion covers the display of the portable electronic device, the magnetic portion is disposed between the shielding portion and the portable electronic device. When the cover portion is flipped over to the rear surface of the portable electronic device, the shielding portion is disposed between the magnetic portion and the portable electronic device. The magnetic portion and shielding portion may be completely transparent or semi-transparent.

### CROSS-REFERENCE TO RELATED APPLICATION

This application claims the priority benefit of U.S. provisional application Ser. No. 62/313,827, filed on Mar. 28, 2016. The entirety of the above-mentioned patent application is hereby incorporated by reference herein and made a part of this specification.

### BACKGROUND APPLICATION

### Field of the Application

The application is related to an accessory, and particularly related to an accessory for portable electronic devices.

### Description of Related Art

With multi-functions and slim design, portable electronic devices such as smart phones and tablet computers are popular with consumers, and so are related accessories. In particular, accessories such as protection case and protection cover are most popular with consumers. A type of protection case is designed in the form of wallet or book cover, and such protection case covers the display (e.g. touch display screen) of the portable electronic device via the cover body of the protection case to avoid possible damage to the display. Likewise, protection cover also has a cover body that can realize the function of protection; however, such protection cover needs to be equipped with magnet to be sensed by the portable electronic device. The portable electronic device senses the protection cover on the display via a Hall sensor or magnet sensor.

### SUMMARY OF THE APPLICATION

The application provides an accessory for protecting a portable electronic device and sensing a rear cover on the portable electronic device.

The application provides an electronic assembly. The accessory of the electronic assembly is capable of sensing a rear cover that covers the portable electronic device.

The application provides an accessory adaptable for a portable electronic device. The portable electronic device includes a display. The accessory includes a coupling portion and a cover portion. The coupling portion is adaptable to be coupled to the portable electronic device. The cover portion is connected with the coupling portion and adaptable to cover the display of portable electronic device. The cover portion includes a magnet or magnetic material layer disposed within the cover portion. A magnetic shield is disposed between the magnet or magnetic material and the cover portion. The cover portion may be a transparent or semi-transparent material.

The application provides an electronic assembly including a portable electronic device and an accessory. The portable electronic device includes a display, a touch sensor and processing unit to form a touch region. The touch sensor covers the display. The processor is coupled to the touch sensor and display. The accessory includes a coupling portion and a cover portion. The coupling portion is adaptable to be coupled to the portable electronic device. The cover portion is connected to the coupling portion and adaptable to cover the display of the portable electronic device. The accessory includes a magnetic portion and a shielding portion. The magnetic portion may be produced by using a transparent material mixed with magnetic material, leading to production of a transparent or semi-transparent structural layer having magnetism. The shielding portion may be disposed above the magnetic portion, and the magnetic portion is disposed between the shielding portion and the portable electronic device. The shielding portion maybe an ITO (indium tin oxide) substrate or glass. The substrate may be polymer, or may be polymer or material coated with ITO pattern or structural layer, leading to production of a transparent or semi-transparent cover portion with magnetism and can be sensed by the sensor of the portable electronic device.

The cover portion may cover the display of portable electronic device. The magnetic portion may cover a portion of the cover portion, or cover a corresponding position of the Hall sensor or magnetic sensor disposed in the portable electronic device.

Based on the above, in the application, the cover portion of the accessory is completely transparent or semi-transparent. When the cover portion covers the display of the portable electronic device, the image shown on the display can pass through the cover portion to be seen by the user. In addition, the accessory can be sensed by the sensor of the portable electronic device via a magnetic field of the magnetic portion disposed in the cover portion. When the cover portion is flipped over to the rear side of the portable electronic device, the accessory is capable of blocking the magnetic field of the magnetic portion from being sensed by the sensor of the portable electronic device via the shielding portion disposed in the cover portion. In addition, the accessory may be in contact with the display of the portable electronic device via a soft layer of the cover portion to prevent scratch caused to the display of the portable electronic device.

In order to make the aforementioned features and advantages of the application more comprehensible, embodiments accompanying figures are described in detail below.

### BRIEF DESCRIPTION OF THE DRAWINGS

FIG. 1 is a schematic view illustrating an accessory and a portable electronic device according to an embodiment of the application separated from each other.

FIG. 2 is a schematic view illustrating the accessory and portable electronic device in FIG. I assembled together.

FIG. 3 is a schematic view illustrating a cover portion of the accessory in FIG. 2 covering a display of the portable electronic device.

FIG. 4A is a cross-sectional view illustrating the accessory in FIG. 3 taken along line I-I in FIG. 3.

FIG. 4B is a partial enlargement view of portion 4B in FIG. 4A.

FIG. 5A is a cross-sectional view illustrating a cover portion of the accessory in FIG. 4A being flipped over to the rear side of a coupling portion thereof.

FIG. 5B is a partial enlargement view illustrating portion 5B in FIG. 5A.

FIG. 6 is a partial enlargement view illustrating a cover portion of an accessory according to another embodiment of the application.

FIG. 7 is a partial enlargement view illustrating a cover portion of an accessory according to another embodiment of the application.

FIG. 8 is a partial enlargement view illustrating a cover portion of an accessory according to another embodiment of the application.

FIG. 9 is a schematic view illustrating a cover portion of an accessory according to another embodiment of the application.

FIG. 10 is a schematic view illustrating a cover portion of an accessory according to another embodiment of the application.

### DESCRIPTION OF EMBODIMENTS

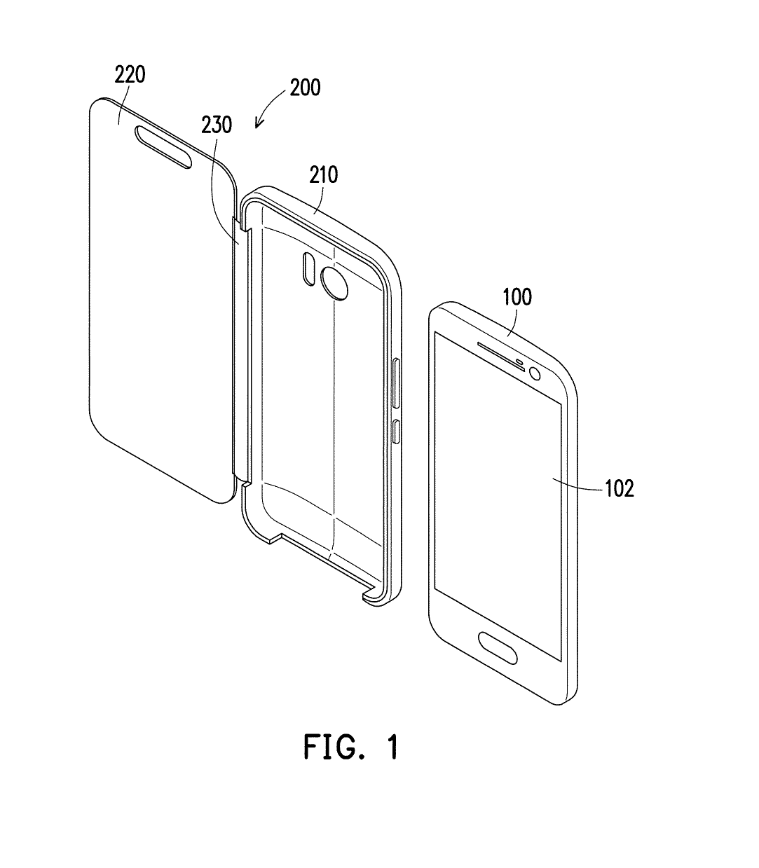

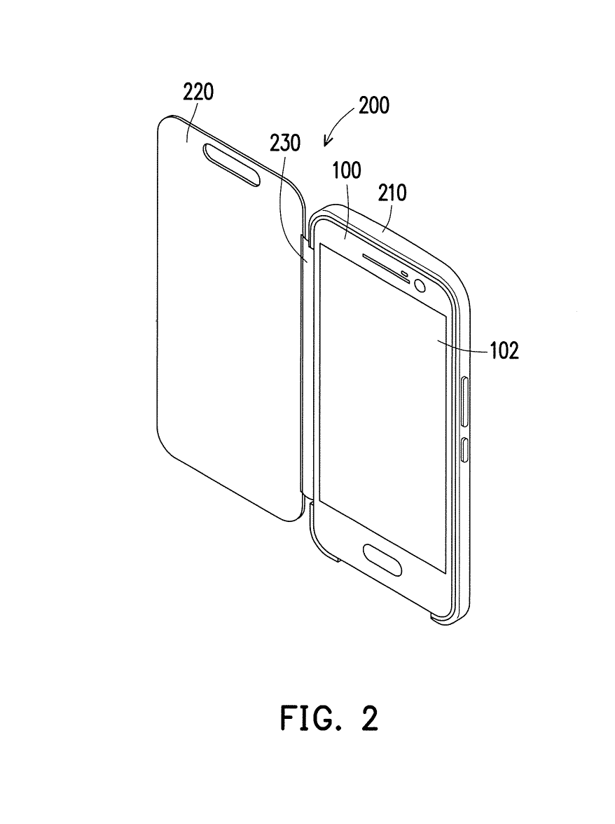

Referring to FIGS. 1-3, an electronic assembly of the embodiment includes a portable electronic device 100 and an accessory 200 for the portable electronic device 100. The accessory 200 may be a cover body which can be flipped over (as shown in FIGS. 2A to 2B) or slid to open. In the embodiment, the portable electronic device 100 may be a smart phone, PDA, tablet computer, notebook computer or any portable electronic device having a display. However, in other embodiments that are not shown, the portable electronic device may be a panel device such as a tablet computer or the like. The portable electronic device 100 includes a display 102. The display 102 may be a liquid crystal display (LCD), an electronic ink display or an organic light emitting diode (OLED) display. The display 102 may be the whole display or a portion of the display.

Referring to FIGS. 1-3, the accessory 200 includes a coupling portion 210, a cover portion 220 and a flexible portion 230. The coupling portion 210 is adaptable to be coupled to the portable electronic device 100. The cover portion 220 is connected with the coupling portion 210 and adaptable to cover the display 102 of the portable electronic device 100. The flexible portion 230 connects the cover portion 220 to the coupling portion 210. In particular, the position of cover portion 220 with respect to the coupling portion 210 may be changed via bending the flexible portion 230 to decide whether to cover the display 102 of the portable electronic device 100. The flexible portion 230 and cover portion 220 may be integrally formed as a single element via an injection molding process or any process. The coupling portion 210 may be coupled to the portable electronic device 100 in four corners thereof to fix the coupling portion 210 to the portable electronic device 100.

To couple the coupling portion 210 to the portable electronic device 100 so as to fix the position of the coupling portion 210 with respect to the portable electronic device 100, the coupling portion 210 may be a recess and adaptable to structurally cover the external side and bottom of the portable electronic device 100 so as to fix the position of the coupling portion 210 with respect to the portable electronic device 100. The cover portion 220 and coupling portion 210 may be formed of a material different from the flexible material. The flexible portion 230 may be maintained in a bended shape and recovered to the bended shape after a force is applied thereto.

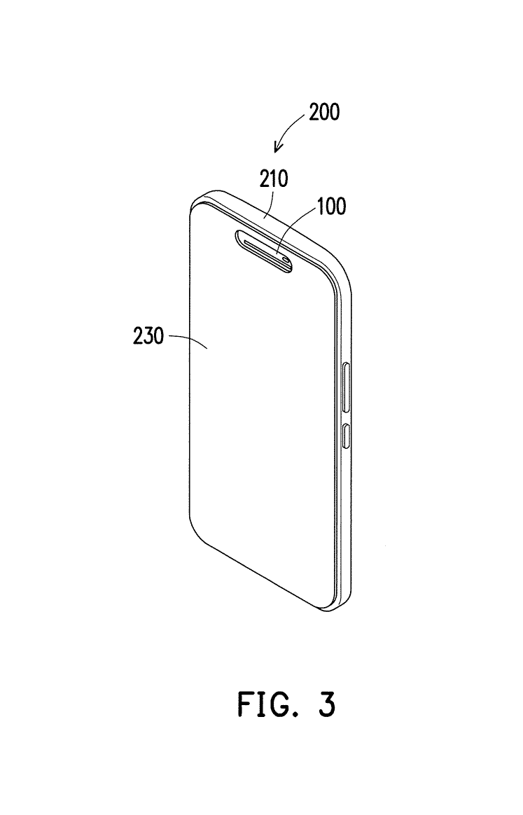

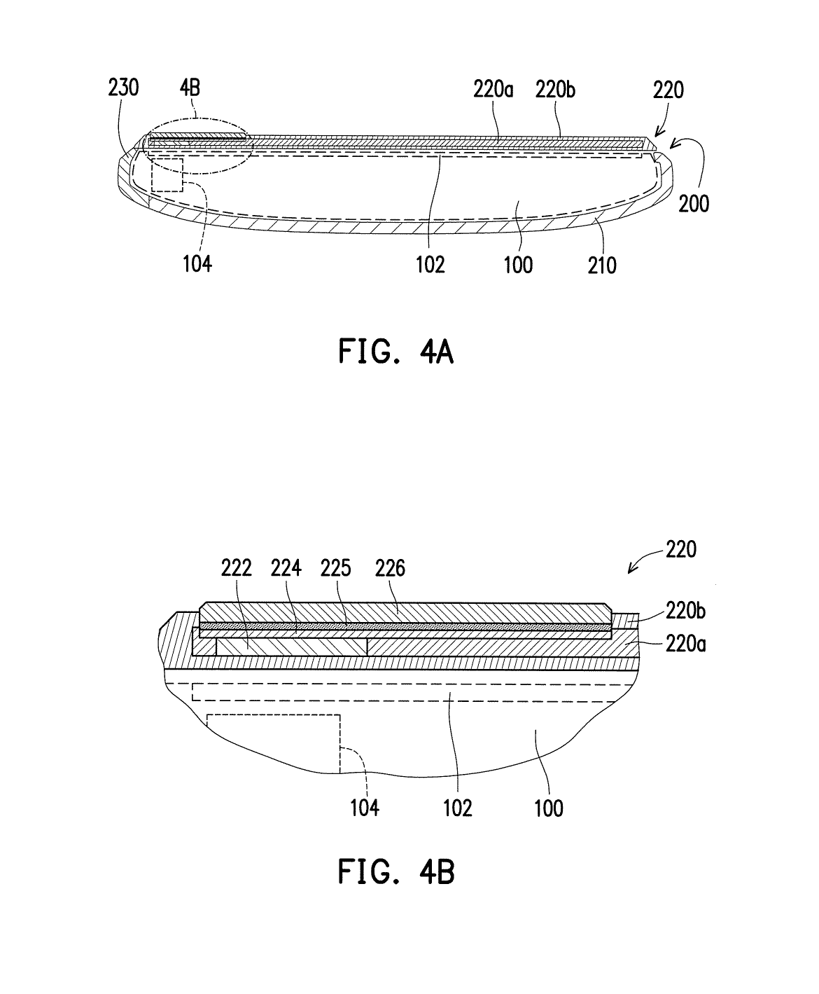

Referring to FIGS. 3, 4A and 4B, to determine whether the cover portion 220 covers the display 102, the portable electronic device 100 includes a sensor 104. The accessory 200 further includes a magnetic portion 222. The determination of whether the display 102 is covered by the cover portion 220 depends on whether the magnetic portion 222 is sensed by the sensor 104. In the embodiment, the sensor 104 may be a magnetic sensor, a Hall effect sensor, or Hall sensor. The magnetic portion 222 may be a permanent magnet, an electrical magnet or magnetic test element. Therefore, the cover portion 220 is capable of covering the display 102 of the portable electronic device 100. The magnetic portion 222 may cover a portion of the cover portion 220, or cover a corresponding position of the sensor 104 disposed in the portable electronic device 100. The sensor 104 is capable of sensing the magnetic pole or magnetic field of the magnetic portion 222.

The position of the magnetic portion 222 may be in the flexible portion 230 or close to the flexible portion 230. The sensor 104 of the portable electronic device 100 may be disposed in the flexible portion 230 or close to the flexible portion 230. When the cover portion 220 is moved from a first position (as shown in FIG. 2) to a second position (as shown in FIG. 3), the magnetic portion 222 is sensed by the sensor 104 of the portable electronic device 100. It should be noted that when the cover portion 220 is moved, as compared with an opposite side of the cover portion 220 away from the flexible portion 230, the displacement of the cover portion 220 is less at one side where the flexible portion 230 is disposed. Therefore, the disposition of the magnetic portion 222 may be close to the flexible portion 230 such that the possibility of erroneous detection caused by sudden move of the cover portion 220 may be reduced. In the embodiment, the cover portion 220 may include a logo piece 226, and the magnetic portion 222 may be disposed under the logo piece 226.

Referring to FIGS. 3, 4A and 4B, the accessory 200 further includes a shielding portion 224. The shielding portion 224 may be disposed above the magnetic portion 222 and overlap the magnetic portion 222. When the cover portion 220 covers the display 102 of the portable electronic device 100, the magnetic portion 222 is disposed between the shielding portion 224 and portable electronic device 100. The cover portion 220 may be flipped over to the rear side of the coupling portion 210 by twisting or turning the flexible portion 230.

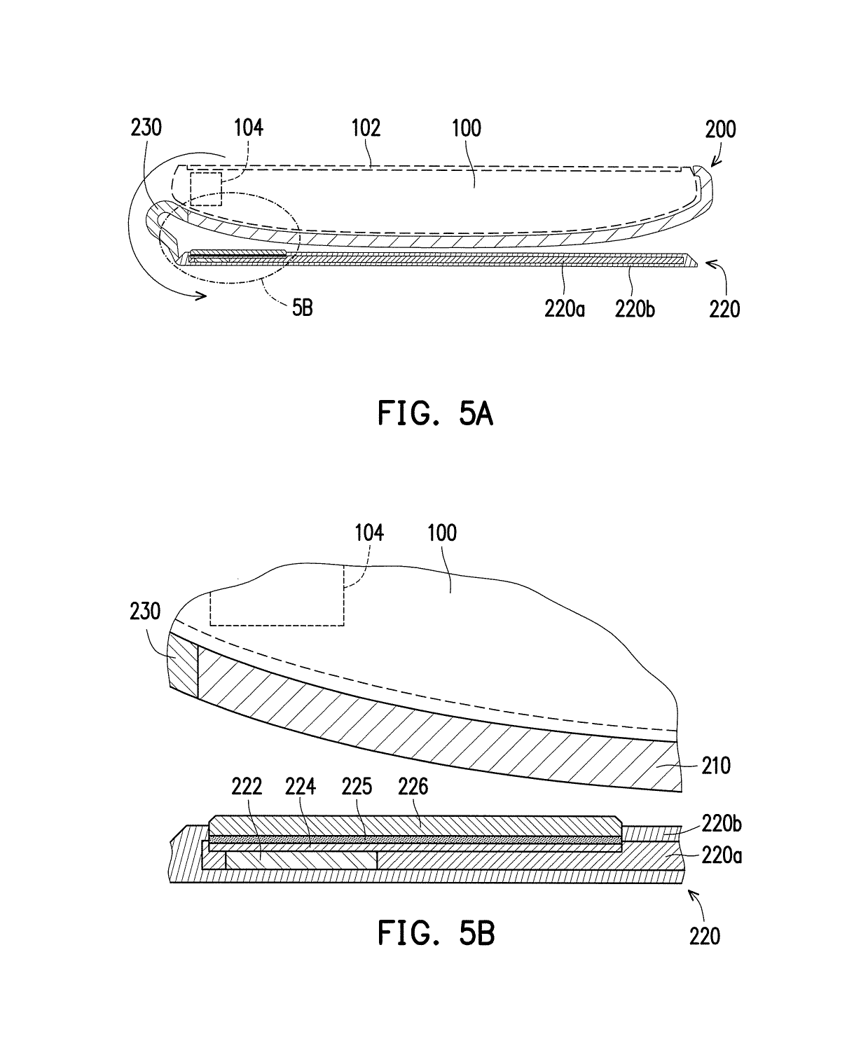

Referring to FIGS. 5A and 5B, when the cover portion 220 is flipped over to the rear surface of the portable electronic device 100, the shielding portion 224 is disposed between the magnetic portion 222 and portable electronic device 100. Therefore, the shielding portion 224 is capable of interfering detection of the sensor 104 from the rear side of the coupling portion 210. By disposing the shielding portion 224 at a position where the coupling portion 210 corresponds to the sensor 104 in the coupling portion 210, the shielding portion 224 blocks the magnetic field of the magnetic portion 222.

Further referring to FIGS. 3, 4A and 4B, the magnetic portion 222 may be disposed within the cover portion 220. The cover portion 220 further includes a hard layer 220a. The magnetic portion 222 is disposed on the hard layer 220a and the shielding portion 224 is disposed above the magnetic portion 222. Specifically, the magnetic portion 222 may be disposed within an opening of the hard layer 220a. A gel may be used to adhere to the shielding portion 224 and magnetic portion 222 to the hard layer 220a. The logo piece 226 may be disposed on the shielding portion 224 with an adhesive layer 225 disposed therebetween. The logo piece 226 is disposed in the cover portion 220 and overlaps the shielding portion 224. However, the logo piece 226 is not necessarily disposed on the shielding portion 224; the logo piece 226 may be disposed at other positions of the cover portion 220. When the hard layer 220a is completely transparent or semi-transparent, light can pass through the cover portion 220, and the image shown on the display 102 of the portable electronic device 100 can pass through the cover portion 220 to be seen by the user. In addition, when the hard layer 220a, magnetic portion 222 and shielding portion 224 are completely transparent or semi-transparent, light can pass through the cover portion 220 (including magnetic portion 222 and shielding portion 224), and the image shown on the display 102 of the portable electronic device 100 can pass through the cover portion 220 to be seen by the user. In the embodiment, the logo piece 226 may be completely transparent or semi-transparent.

When the magnetic portion 222 is completely transparent or semi-transparent, the magnetic portion 222 may be formed of a transparent material mixed with a magnetic material. In other words, the magnetic portion 222 may be constituted by a transparent material and a magnetic material mixed therein.

When the shielding portion 224 is completely transparent or semi-transparent, the shielding portion 224 may be an ITO (indium tin oxide) substrate or glass. The substrate may be polymer or a material coated with an ITO pattern or structural layer. In addition, the shielding portion 224 may be formed of a transparent material mixed with a shielding material. That is, the shielding portion 224 may be constituted by a transparent material and a shielding material mixed therein.

The cover portion 220 further includes a soft layer 220b which is completely transparent or semi-transparent. The hard layer 220a, magnetic portion 222 and shielding portion 224 may be disposed within the soft layer 220b. The soft layer 220b may be completely transparent or semi-transparent. As compared with the hard layer 220a, the soft layer 220b is softer and may have different color or different transparency to form the cover portion 220 that exhibits a special visual effect as a whole. Likewise, when the magnetic portion 222 and shielding portion 224 are completely transparent or semi-transparent, the magnetic portion 222 and shielding portion 224 may also have different color or different transparency to form the cover portion 220 that exhibits a special visual effect as a whole.

In another embodiment, when the magnetic portion 222 and shielding portion 224 are non-transparent, the magnetic portion 222 may be a magnet. The shielding portion 224 may be any ferromagnetic metal, i.e. any object that contains iron, nickel, or cobalt. The shielding portion 224 serves as a magnetic shielding that blocks the magnetic field on the rear side of the coupling portion 210 for the sensor 104.

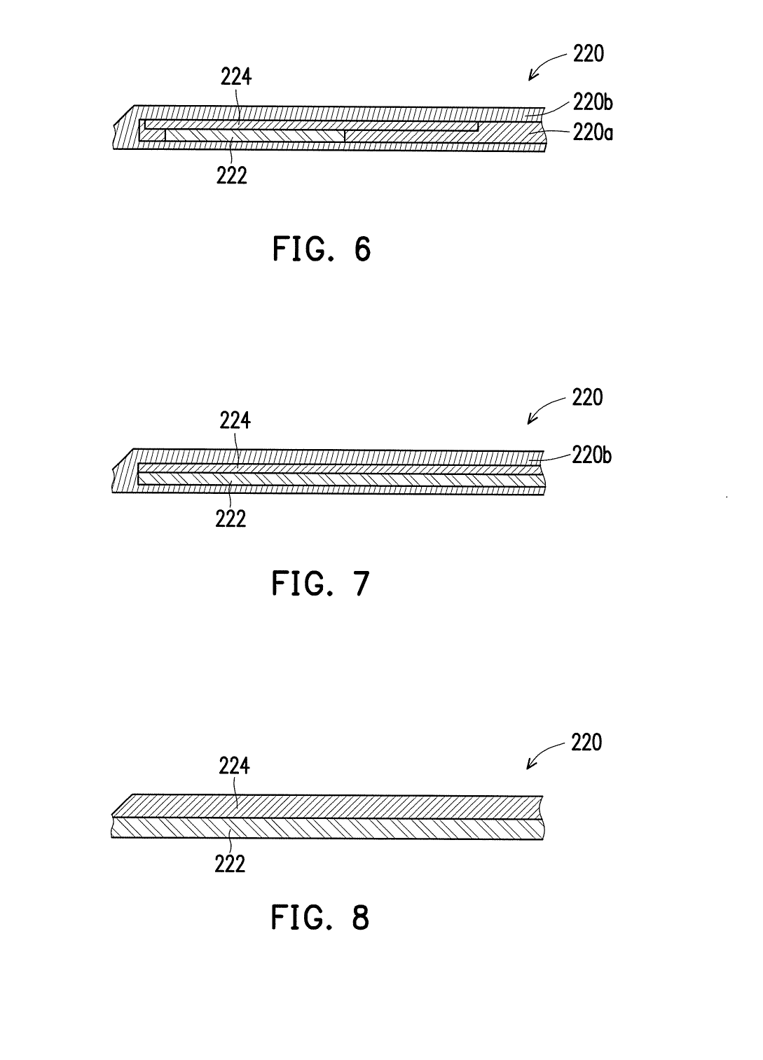

Referring to FIG. 6, as compared with the embodiment in FIG. 3, the cover portion 220 does not include the logo piece in FIG. 3; thus, the soft layer 220b may cover the shielding portion 224 to maintain flatness of the appearance of cover portion 220.

Referring to FIG. 7, in the embodiment, the magnetic portion 222 and shielding portion 224 may be disposed together within the cover portion 220. Specifically, the magnetic portion 222 and shielding portion 224 may be similarly constituted as the hard layer 220a in FIG. 3 and be covered by the soft layer 220b. To allow light to pass through the cover portion 220, the hard layer 220a, soft layer 220b, magnetic portion 222 and shielding portion 224 may be completely transparent or semi-transparent.

Referring to FIG. 8, in the embodiment, the magnetic portion 222 may be a structural layer of the cover portion 220, forming into a structure of the cover portion 220 that covers the display 102. In other words, the magnetic portion 222 may be the cover portion 220, and the magnetic portion 222 may a large structural layer that covers the entire display 102. The shielding portion 224 is disposed above the magnetic portion 222. The position of the magnetic portion 222 may be between the shielding portion 224 and portable electronic device 100. The magnetic portion 222 and shielding portion 224 together may form the whole cover portion 220. To allow light to pass through the cover portion 220, the magnetic portion 222 and shielding portion 224 may be completely transparent or semi-transparent.

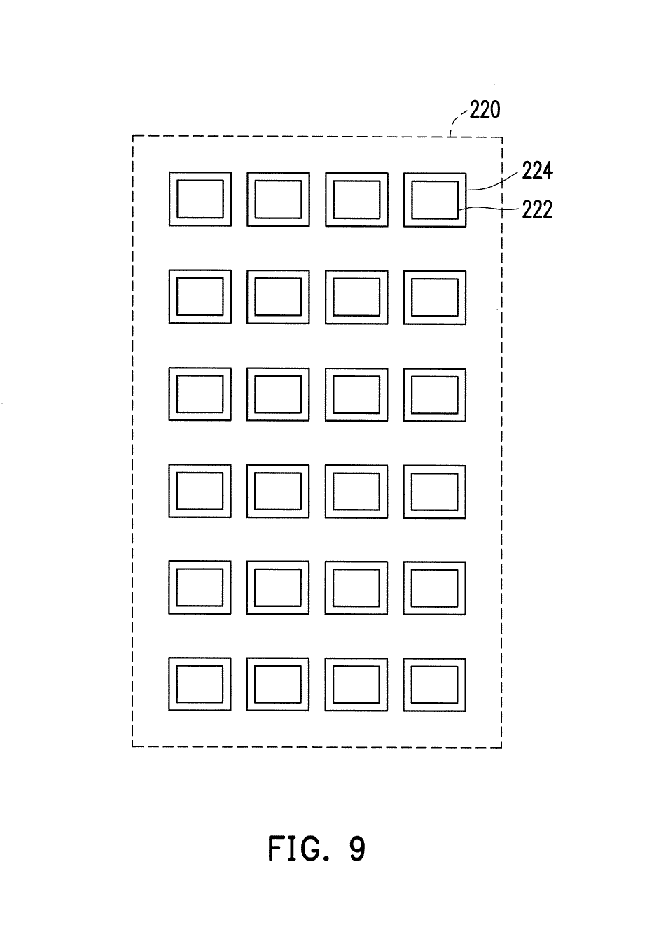

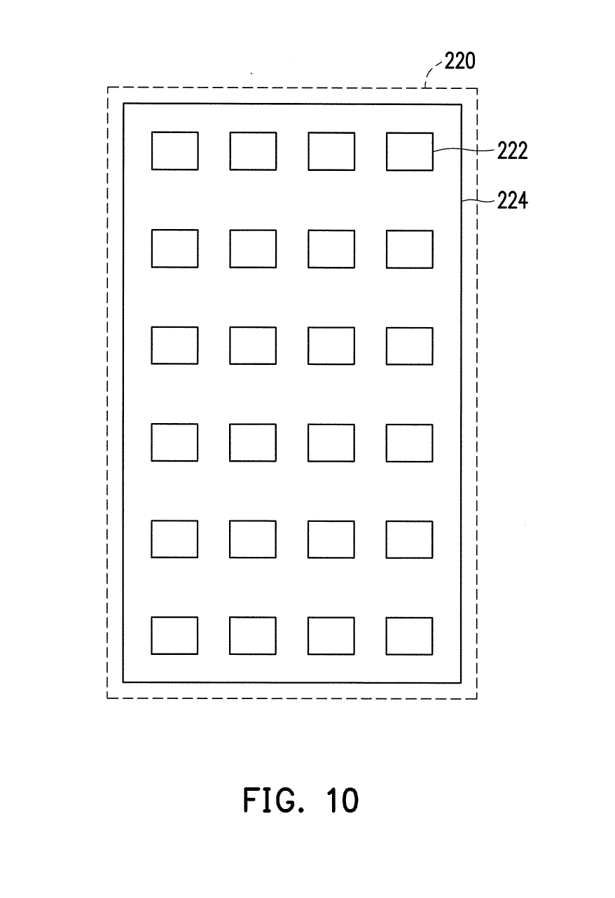

Referring to FIG. 9, in the embodiment, the magnetic portion 222 may include a plurality of magnetic layers that are arranged in array or matrix on the cover portion 220. The shielding portion 224 may also include a plurality of shielding layers that are arranged in array or matrix corresponding to the magnetic portion 222 on the cover portion 220. With such configuration, the magnetic layers 222a or shielding layers 224a may be completely transparent or semi-transparent.

Referring to FIG. 10, in another embodiment, the shielding portion 224 may also include a single shielding layer 224a which includes the magnetic layers 222a of the magnetic portion 222 and is disposed on the cover portion 220. With such configuration, the magnetic layers 222a and shielding layers 224a may be completely transparent or semi-transparent.

In summary of the above, in the application, the cover portion of accessory is completely transparent or semi-transparent. When the cover portion covers the display of the portable electronic device, the image shown on the display can pass through the cover portion to be seen by the user. In addition, the accessory can be sensed by the sensor of the portable electronic device via the magnetic field of the magnetic portion disposed in the cover portion. When the cover portion is flipped over to the rear side of the portable electronic device, the magnetic field of the magnetic portion may be blocked via the shielding portion disposed in the cover portion so that the accessory can be sensed by the sensor of the portable electronic device. In addition, the accessory may be in contact with the display of the portable electronic device via the soft layer of the cover portion to avoid scratches caused to the display of the portable electronic device.

Although the application has been disclosed by the above embodiments, the embodiments are not intended to limit the application. It will be apparent to those skilled in the art that various modifications and variations can be made to the structure of the application without departing from the scope or spirit of the application. Therefore, the protecting range of the application falls in the appended claims.

What is claimed is:

1. An accessory, adaptable for a portable electronic device, the portable electronic device comprising a display and a rear surface facing away from the display, the accessory comprising:
a cover portion being completely transparent or semi -transparent and adaptable to cover the display of the portable electronic device;
a magnetic portion, disposed within the cover portion; and
a shielding portion, disposed within the cover portion, wherein when the cover portion covers the display of the portable electronic device, the magnetic portion is disposed between the shielding portion and the portable electronic device, when the cover portion is flipped over to the rear surface of the portable electronic device, the shielding portion is disposed between the magnetic portion and the portable electronic device.

2. The accessory according to claim 1, wherein the magnetic portion is constituted by a transparent material and a magnetic material mixed therein.

3. The accessory according to claim 1, wherein the shielding portion comprises a transparent substrate and a transparent conductive layer disposed on the transparent substrate.

4. The accessory according to claim 1, wherein the shielding portion is constituted by a transparent material and a shielding material mixed therein.

5. The accessory according to claim 1, wherein the magnetic portion comprises a plurality of magnetic layers arranged in array or matrix on the cover portion.

6. The accessory according to claim 5, wherein the shielding portion comprises a plurality of shielding layers respectively arranged on the cover portion corresponding to the magnetic layers.

7. The accessory according to claim 5, wherein the shielding portion comprises a single layer including the magnetic layers and disposed on the cover portion.

8. The accessory according to claim 1, further comprising:
a logo piece, embedded in the cover portion and overlapping the shielding portion.

9. The accessory according to claim 1, further comprising:
a coupling portion, connected with the cover portion and adaptable to be coupled to the portable electronic device.

10. The accessory according to claim 1, further comprising:
a flexible portion, connecting the cover portion to the coupling portion.

11. An accessory, adaptable for a portable electronic device, the portable electronic device comprising a display and a rear surface facing away from the display, the accessory comprising:
a cover portion, comprising a hard layer and a soft layer covering the hard layer, and adaptable to cover the display of the portable electronic device;
a magnetic portion, disposed within the cover portion; and
a shielding portion, disposed within the cover portion, wherein when the cover portion covers the display of the portable electronic device, the magnetic portion is disposed between the shielding portion and the portable electronic device, when the cover portion is flipped over to the rear surface of the portable electronic device, the shielding portion is disposed between the magnetic portion and the portable electronic device.

12. The accessory according to claim 11, wherein the magnetic portion is disposed within an opening of the hard layer.

13. The accessory according to claim 11, wherein the shielding portion and the magnetic portion are overlapped.

14. The accessory according to claim 11, wherein the magnetic portion is completely transparent or semi-transparent.

15. The accessory according to claim 11, wherein the shielding portion is completely transparent or semi-transparent.

16. The accessory according to claim 11, wherein the magnetic portion comprises a plurality of magnetic layers arranged in array or matrix on the cover portion.

17. The accessory according to claim 16, wherein the shielding portion comprises a plurality of shielding layers respectively arranged on the cover portion corresponding to the magnetic layers.

18. The accessory according to claim 16, wherein the shielding portion comprises a single shielding layer including the magnetic layers and disposed on the cover portion.

19. The accessory according to claim 11, further comprising:
a logo piece, disposed in the cover portion and overlapping the shielding portion.

20. The accessory according to claim 11, further comprising:
a coupling portion, connected with the cover portion and adaptable to be coupled to the portable electronic device.

21. The accessory according to claim 11, further comprising:
a flexible portion, connecting the cover portion to the coupling portion.

22. An accessory, adaptable for a portable electronic device, the portable electronic device comprising a display and a rear surface facing away from the display, the accessory comprising:
a cover portion, comprising a hard layer and a soft layer covering the hard layer, and adaptable to cover the display of the portable electronic device, wherein the hard layer and the soft layer are completely transparent or semi-transparent;
a magnetic portion, disposed within the cover portion; and
a shielding portion, disposed within the cover portion, wherein when the cover portion covers the display of the portable electronic device, the magnetic portion is disposed between the shielding portion and the portable electronic device, when the cover portion is flipped over to the rear surface of the portable electronic device, the shielding portion is disposed between the magnetic portion and the portable electronic device.

23. The accessory according to claim 22, wherein the magnetic portion is disposed within an opening of the hard layer.

24. The accessory according to claim 22, wherein the shielding portion and the magnetic portion are overlapped.

25. The accessory according to claim 22, wherein the magnetic portion is completely transparent or semi-transparent.

26. The accessory according to claim 22, wherein the shielding portion is completely transparent or semi-transparent.

27. The accessory according to claim 22, wherein the magnetic portion comprises a plurality of magnetic layers arranged in array or matrix on the cover portion.

28. The accessory according to claim 27, wherein the shielding portion comprises a plurality of shielding layers respectively arranged on the cover portion corresponding to the magnetic layers.

29. The accessory according to claim 27, wherein the shielding portion comprises a single shielding layer including the magnetic layers and disposed on the cover portion.

30. The accessory according to claim 22, further comprising:
a logo piece, disposed in the cover portion and overlapping the shielding portion.

31. The accessory according to claim 22, further comprising:
a coupling portion, connecting with the cover portion and adaptable to be coupled to the portable electronic device.

32. The accessory according to claim 22, further comprising:
a flexible portion, connecting the cover portion to the coupling portion.
